(19) United States
(12) Patent Application Publication
(10) Pub. No.: US 2002/0112145 A1
(43) Pub. Date: Aug. 15, 2002

(54) Method and apparatus for providing software compatibility in a processor architecture

(76) Inventors: Bryant E. Bigbee, Scottsdale, AZ (US); Frank Binns, Hillsbord, OR (US); Kaushik Shiv, Portland, OR (US); Patrice Roussel, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/783,771

(22) Filed: Feb. 14, 2001

(51) Int. Cl. G06F 9/00

(52) U.S. Cl. 712/43; 712/229

(57) ABSTRACT

A method and apparatus for providing software compatibility in a processor architecture. In one embodiment, a method involves accessing a control register mask and adjusting a control value for a control register as a function of the control register mask. The masked control value is programmed into the control register.

### BACKGROUND

As new microprocessor architectures are developed, it becomes increasingly important for applications to be able to take advantage of new architectural features while maintaining compatibility with existing microprocessor architectures. Currently, some applications use processor specific family, model and stepping information returned by a CPUID instruction to determine the feature set of a particular microprocessor architecture. However, the CPUID method may require software vendors to update their code with the latest microprocessor identification information with every new generation of microprocessor, adding cost and complexity.

Additionally, some operating systems implement somewhat crude methods to protect against application errors resulting from incompatibility. Particularly, some operating systems protect themselves from inadvertent application errors using a hard-coded constant that is likely to need updating whenever new features are added to the processor architecture.

Thus, some techniques exist for maintaining backward compatibility while new processor features are added. As a result of limitations on such compatibility mechanisms, processor manufacturers may be unable to easily or conveniently extend hardware architectures to provide new features for applications and operating system vendors in a manner that is backward compatible with previous generations of such applications and operating systems. Therefore a new technique allowing application software compatibility among processor architectures is desirable.

### BRIEF DESCRIPTION OF THE FIGURES

The features and advantages of the invention will become apparent from the following detailed description in which:

FIG. 1 is a block diagram illustrating an exemplary computer system according to one embodiment.

FIG. 2 is a diagram illustrating a control register according to one embodiment.

FIG. 3 is a diagram illustrating a memory image containing a control register mask field according to one embodiment.

FIG. 4 is a diagram illustrating a State Saving and State Restoring instructions according to one embodiment.

FIG. 5 is a flow diagram illustrating a method for facilitating software compatibility in a software architecture according to one embodiment.

FIG. 6 is a diagram illustrating a microprocessor according to one embodiment.

### DETAILED DESCRIPTION

In the following description, for purposes of explanation, numerous details are set forth in order to provide a thorough understanding of the invention. However, it will be apparent to one skilled in the art that these specific details are not required in order to practice the invention. In other instances, well-known electrical structures and circuits are shown in block diagram form in order not to obscure the invention unnecessarily.

A Computer System

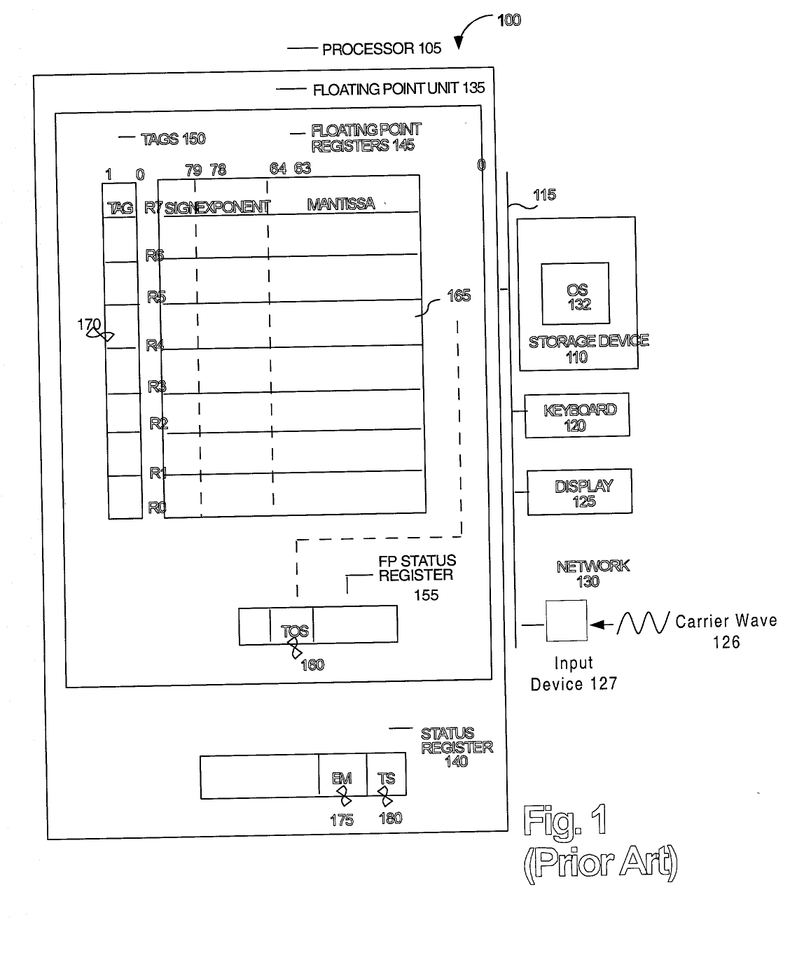

FIG. 1 is a diagram illustrating one embodiment of a computer system. Computer system 100 comprises a processor 110, a storage device 120, and a bus 115. The processor 110 is coupled to the storage device 120 by the bus 115. In addition, a number of user input/output devices 140 (e.g., keyboard, mouse) are also coupled to the bus 115. The processor 110 represents a central processing unit of any type of architecture, such as CISC, RISC, VLIW, or hybrid architecture. In addition, the processor 110 could be implemented on one or more chips. The storage device 120 represents one or more mechanisms for storing data. For example, the storage device 120 may include read only memory (ROM), random access memory (RAM), magnetic disk storage mediums, optical storage mediums, flash memory devices, and/or other machine-readable mediums. The bus 115 represents one or more buses (e.g., AGP, PCI, ISA, X-Bus, VESA, etc.) and bridges (also termed as bus controllers). While this embodiment is described in relation to a single processor computer system, a multi-processor computer system could also be implemented.

In addition to other devices, one or more of a network controller 155, a TV broadcast signal receiver 160, a fax/modem 145, a video capture card 135, an audio card 150, and a graphics controller 130 may optionally be coupled to bus 115. The network controller 155 represents one or more network connections (e.g., an Ethernet connection). While the TV broadcast signal receiver 160 represents a device for receiving TV broadcast signals, the fax/modem 145 represents a fax and/or modem for receiving and/or transmitting analog signals representing data. The image capture card 135 represents one or more devices for digitizing images (i.e., a scanner, camera, etc.). The audio card 150 represents one or more devices for inputting and/or outputting sound (e.g., microphones, speakers, magnetic storage devices, optical storage devices, etc.). The graphics controller 130 represents one or more devices for generating images (e.g., graphics card).

FIG. 1 also illustrates that the storage device 120 has stored therein data 124 and program code 122. Data 124 represents data stored in one or more of the formats described herein. Program code 122 represents the necessary code for performing any and/or all of the techniques performed by the computer system. Of course, the storage device 120 preferably contains additional software (not shown).

FIG. 1 additionally illustrates that the processor 110 includes a decode unit 116, a set of registers 114, an execution unit 112, and an internal bus 111 for executing instructions. Of course, the processor 110 contains additional circuitry. The decode unit 116, registers 114 and execution unit 112 are coupled together by the internal bus 111. The decode unit 116 is used for decoding instructions received by processor 110 into control signals and/or microcode entry points. In response to these control signals and/or microcode entry points, the execution unit 112 performs the appropriate operations. The decode unit 116 may be implemented using any number of different mechanisms (e.g., a look-up table, a hardware implementation, a PLA, etc.). While the decoding of the various instructions is represented herein by a series of if/then statements, it is understood that the execution of an instruction does not require a serial processing of these if/then statements. Rather, any mechanism for logically performing this if/then processing may be used.

The decode unit 116 is shown including the processor state as a save state and a restore state instruction that respectively saves and restores data 124 in the formats described herein. In addition to the save and restore instructions, the processor 110 can include new instructions and/or instructions similar to or the same as those found in existing general-purpose processors. For example, in one embodiment the processor 110 supports an instruction set which: 1) is compatible with the Intel Architecture instruction set used by existing processors (such as the Pentium® Pro processor); and 2) includes new extended instructions that operate on “extended operands”. In one embodiment, the extended instructions are Single Instruction Multiple Data (SIMD) floating-point instructions that operate on 128-bit packed data operands, having four single-precision data elements. Alternative embodiments could implement different instructions (e.g., scalar, integer, etc.) Alternative embodiments may contain more or less, as well as different, packed data instructions.

The registers 114 represent a storage area on processor 110 for storing information, including control/status information, integer data, floating point data, integer packed data and extended operand data. The storage area used for storing the control/status information and packed data is not critical.

State Saving & Restoring Instructions

Upon START, the system process P400 enters block B410. In block B410, the task switch (TS) flag is reset, i.e., TS is loaded with 0. This indicates that a task switching has not occurred. The process P400 then enters block B415 in which task A is running. At block B420, it is determined if task A is preempted by task B. If task A is not preempted by task B, then it is determined if task A has been completed. If task A has been completed, the process P400 is terminated. If task A has not been completed, the process P400 goes back to block B415 to continue running task A.

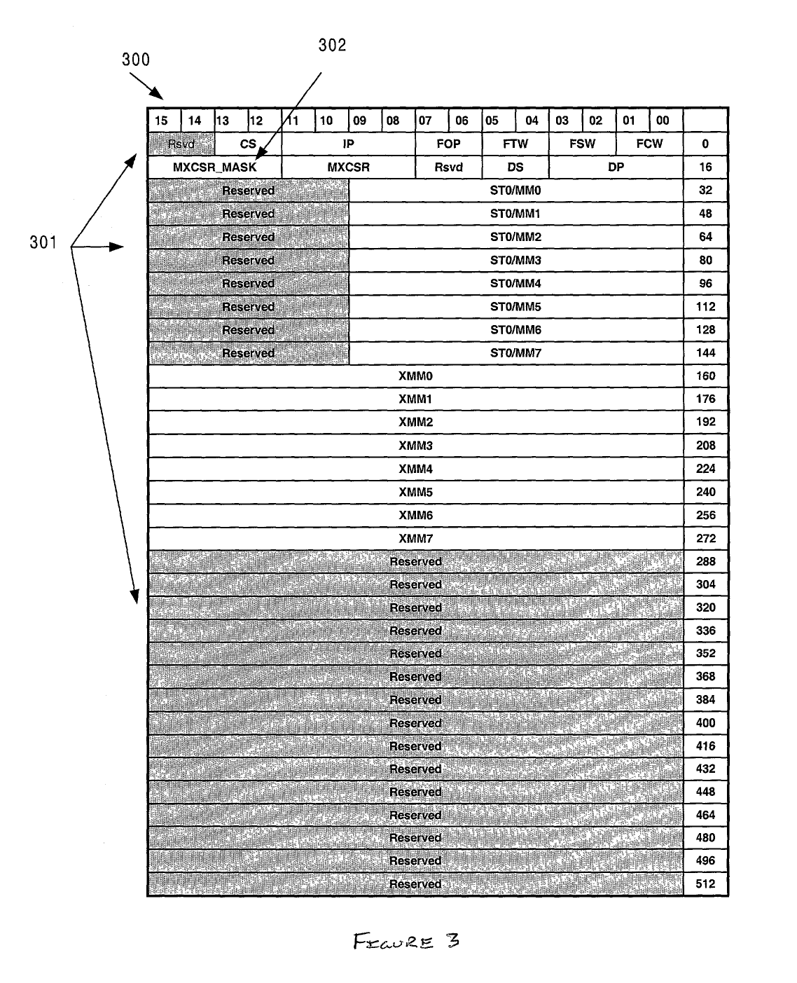

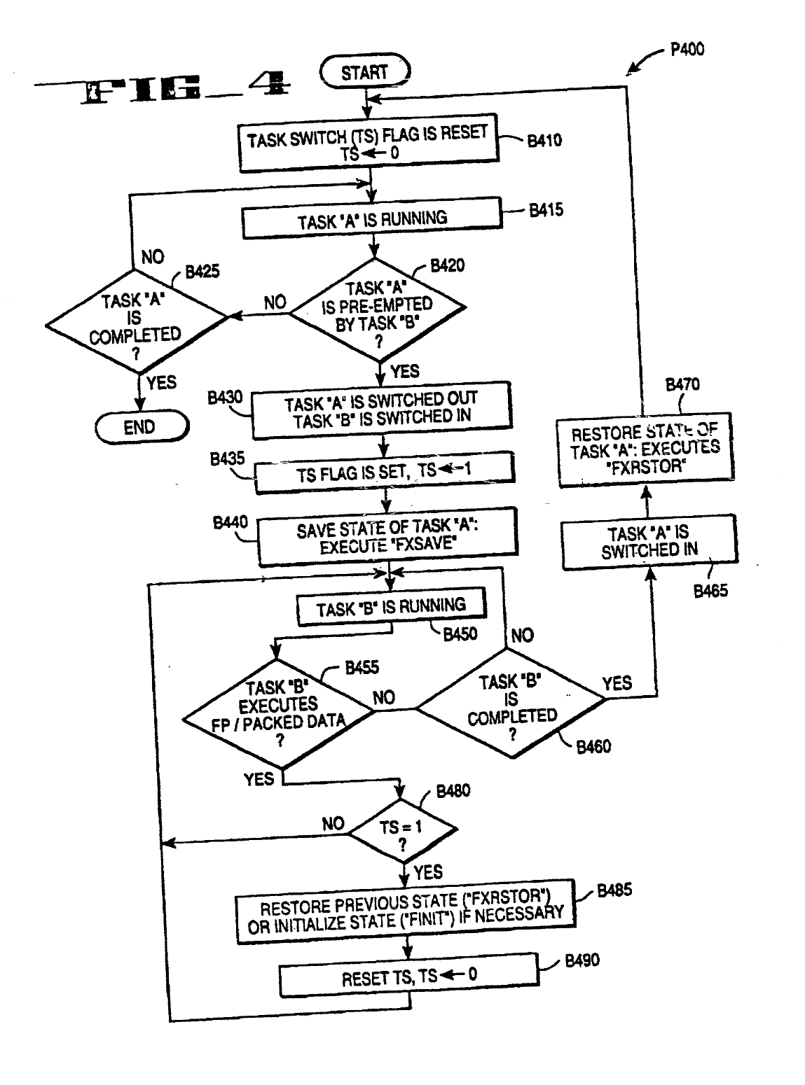

If task A is preempted by task B, then the process block B400 enters block B430. In block B430, task A is switched out and task B is switched in. Then the TS flag is set, i.e., TS is loaded with 1, in block B435 to indicate that a task switching has occurred. While the OS will store part of the processor state for task A, the OS has the option of saving the state shown in FIG. 3 (the aliased registers, extended registers, and associated control and status information etc.) referred to as the “optional state”. In particular, the operating system may either save the optional state for task A regardless of whether task B utilizes the aliased or extended registers or save the optional state for task A only if and when task B utilizes the aliased or extended systems. In one embodiment shown in FIG. 4, the process P400 saves the optional state of task A in block B440. Executing a state save instruction saves the state of task S. In one embodiment, the state save instruction is an “FXSAVE” instruction.

The process P400 then enters block B450. In block B450, task B is running. While task B is running, it is determined in block B455 if task B utilizes the aliased or extended registers by executing the associated instructions. If it is determined that task B does not utilize the aliased or extended registers, it is then determined if task B is completed in block B460. If task B has not been completed, the process P400 returns back to block B450. If task B is completed, the process P400 enters block B465 to switch task A in. The state of task A is then restored in block B470 by executing a state restore instruction. In one embodiment, the state restore instruction is an “FXRSTOR” instruction. The process P400 then returns back to block B410 to reset the task switch flag.

If in block B455, it is determined that task B utilizes the Floating Point Unit (FPU) and the packed data/ extended packed data unit, the process P400 enters block B480 to determine if a task switch has occurred. If a task switch has not occurred, i.e., if TS=0, then the process P400 returns back to block S450 to continue running task B. If YES, i.e., if TS=1, the process P400 enters block B485. In block B485, the process either restores the previous state by executing the FXRSTOR instruction, or initializes the state by executing the an initialization instruction, such as an FINIT instruction, depending on the particular implementation of the operating system. The process P400 then enters block B490 to reset the TS flag to 0 so that block B485 would not be performed if task B executes an instruction related to the FPU, packed data/extended packed data again. The process P400 then returns back to block B450.

In one embodiment, the saving of task A in block B440 can be performed after block B480 when it is determined that task B first executes an FPU, packed data, or extended packed data instruction.

Various techniques can be used in conjunction with the saving and restoring of processor state responsive to switching of tasks. For example, some operating system store and restore all of the processor state on each task switch. However, it has been determined that there are often parts of the processor state that may not need to be stored (e.g., a task did not alter the state). To take advantage of the situations where the entire state does not need to be saved and/or restored, certain processors provide exceptions to the operating system to allow the operating system to avoid saving and restoring the entire processor state. In addition, the task switch flag bit may be associated with any of the register sets, including the aliased floating point/packed data registers and the extended registers. While certain examples of task switching techniques are described, other embodiments may use other switching techniques.

A Control Register

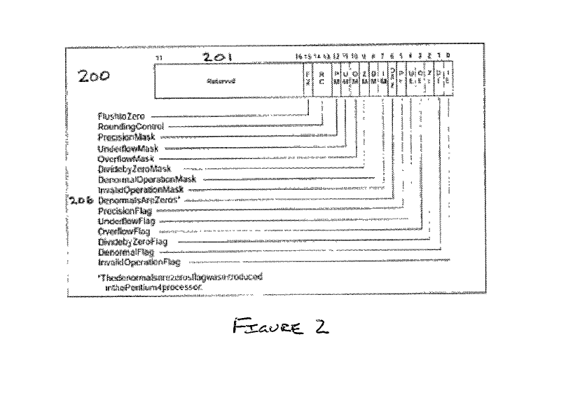

FIG. 2 illustrates a layout of a control register according to one embodiment of the invention. In one embodiment, the control register is an MXCSR register 200. Bits 16-31 are reserved 201 for future functionality, while bits 0-15 may be written to enable or disable functions supported within a microprocessor. Furthermore, the MXCSR register may be read to determine the functionality of a particular processor family. For example, in one embodiment, the microprocessor supports the DenormalsAreZeros flag 206, which is a function not supported by some microprocessors. Microprocessors supporting this feature may contain a default value of 0xFFFFh within the MXCSR register. In earlier processors, the DenormalsAreZero function is not supported, and therefore, the MXCSR register may contain a default of 0xFFBFh, indicating a zero value in the DAZ bit.

In one embodiment, write operations issued to a reserved bit in the control register may cause the processor to respond in an unpredictable manner or respond with an exception error. For example, writing a one to the DAZ bit in the MXCSR register of a processor supporting this feature will cause the DAZ function to be enabled, whereas the same write operation to a processor not supporting this feature may result in an exception. A mask field may be used to prevent write operations from writing to reserved bits within the MXCSR register.

Memory Image

FIG. 3 illustrates a layout of an memory image 300 according to one embodiment. In one embodiment, the memory image is generated by executing a state saving instruction, such as an FXSAVE instruction, which creates an FXSAVE memory image. The FXSAVE memory image enables software to communicate with a microprocessor by storing the contents of certain architecture registers within the microprocessor. Software may access processor architecture registers by writing to or reading from locations within the memory image in which the processor architecture registers are mapped. The FXSAVE memory image may exist in various memory structures including, but not limited to, cache memory or Dynamic Random-Access Memory (DRAM).

In one embodiment, the FXSAVE memory image is 512 bytes in length, and aligned on a 512-byte boundary so as to facilitate optimal hardware performance. Unused fields in the FXSAVE memory image are reserved 301 for future functionality, and, in one embodiment, executing an FXSAVE instruction while addressing reserved fields within the memory image may generate an exception error or cause the processor enter an unpredictable state.

The MXCSR_MASK 302 is used in one embodiment to indicate supported functions of a processor and act as a bit mask for write operations to the processor's MXCSR register. In one embodiment, the MXCSR register may be written to enable or disable functionality of a processor in which it is contained. Since the MXCSR may contain reserved bits for future processor functionality, it may be necessary to protect these bits from being set by write operations to the MXCSR register. In one embodiment, these bits are protected by performing a logical AND operation between the MXCSR_MASK and the value to be written to the MXCSR register. For example, a value to be written to the MXCSR register such as, 0xPFFFh, AND'ed with an MXCSR_MASK value of 0xFFBFh would result in the value 0xFFBFh written to the MXCSR register.

In one embodiment, the MXCSR_MASK is updated with a current state of the MXCSR register upon the execution of an FXSAVE instruction addressed to a location within the FXSAVE memory image. A write operation to reserved bits within the MXCSR register may result in an invalid processor state or an exception error. Therefore, a write operation preceded by an AND operation between the MXCSR_MASK and the data to be written to the MXCSR register may, in one embodiment, result in the processor being configured to a valid state.

Software Compatibility

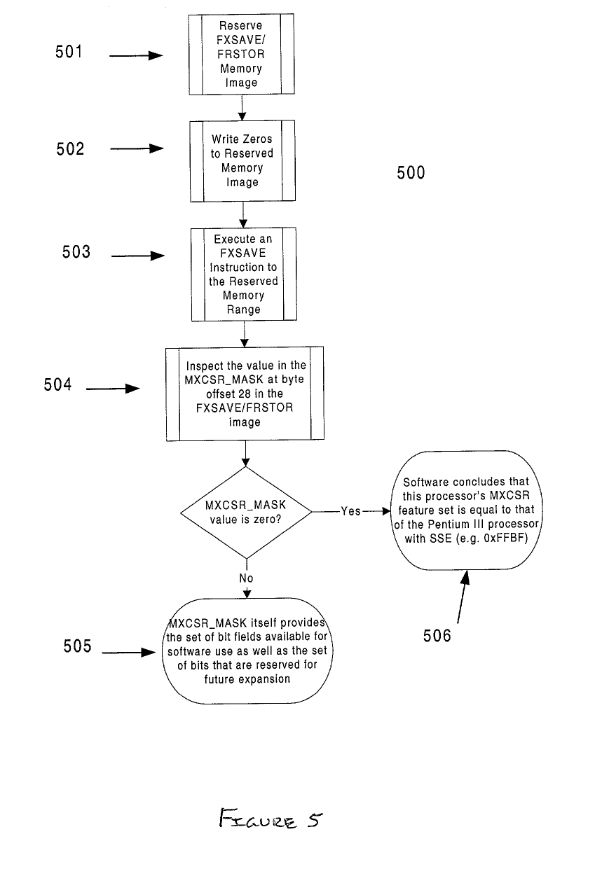

FIG. 5 illustrates one method 500 of providing software compatibility within a processor architecture according to one embodiment. A method and apparatus is described for determining whether a microprocessor supports a software compatibility scheme described herein, and, if so, what functions are supported by the microprocessor. In one embodiment, a software program may be used. However, one of ordinary skill in the art would appreciate that other implementations may be used, including, but not limited to, a hardware implementation.

In one embodiment, a memory range of 512 bytes is reserved for an FXSAVE memory image, in which an MXCSR_MASK field is stored 501. It will be appreciated by one of ordinary skill in the art that the memory image used by a state save operation, such as FXSAVE is not limited to 512 bytes.

In one embodiment, after an FXSAVE memory image is reserved, the FXSAVE memory image is initialized by writing zeros 502 to the MXCSR_MASK. In other embodiments other values may be used to initialize the MXCSR_MASK. It is also not necessary to only initialize the MXCSR_MASK within the FXSAVE memory image. For example, in one embodiment, the entire FXSAVE memory image is initialized to zeros.

An FXSAVE instruction is executed 503, having associated with it, a target address within the FXSAVE memory image. In one embodiment, this address is the first byte within the memory image. In one embodiment, an FXSAVE instruction executed at an address within the FXSAVE memory image writes the current state of the MXCSR register to the MXCSR_MASK field within the FXSAVE memory image.

In some earlier processors, executing an FXSAVE instruction will not write the state of the MXCSR register to the MXCSR_MASK field. Therefore, a comparison 504 between the value written to MXCSR_MASK field and the value existing within the MXCSR_MASK field after executing the FXSAVE will not be equal. For example, in one embodiment, in which zeros are written to the MXCSR_MASK field initially, the MXCSR_MASK field will contain zeros after executing an FXSAVE instruction at an address within the FXSAVE memory image in some earlier processors. Furthermore, in one embodiment, the MXCSR_MASK field containing zeros after an FXSAVE instruction is executed at an address within the FXSAVE memory image indicates that the processor does not support the compatibility scheme described herein 505. Therefore, a default MXCSR register value such as, 0xFFBFh, would be used as a mask field for future writes to the MXCSR register instead of the contents of the MXCSR_MASK field.

Alternatively, if after executing an FXSAVE instruction at a location within the FXSAVE memory image, a value other than that which was written to the MXCSR_MASK field prior to the execution of the FXSAVE instruction exists, then the MXCSR_MASK field is used as a mask value for subsequent write operations to the MXCSR register 506. In one embodiment, in which zeros are written to the MXCSR_MASK field, the MXCSR_MASK field, after executing an FXSAVE instruction at an address within the MXCSR_MASK memory image, will contain a default value, 0xFFFF, indicating that the DenormalsAreZero (DAZ) flag is enabled. Since the DAZ flag is a feature implemented on some later processors, a conclusion may be made that the processor is of a family that supports the DAZ flag feature and therefore supports the compatibility techniques described herein. Furthermore, the value existing within the MXCSR_MASK as a result of an FXSAVE instruction being executed at a location within the FXSAVE memory image, may be used as a mask field for values subsequently written to the MXCSR register. This prevents a microprocessor from entering an invalid state or returning an exception error.

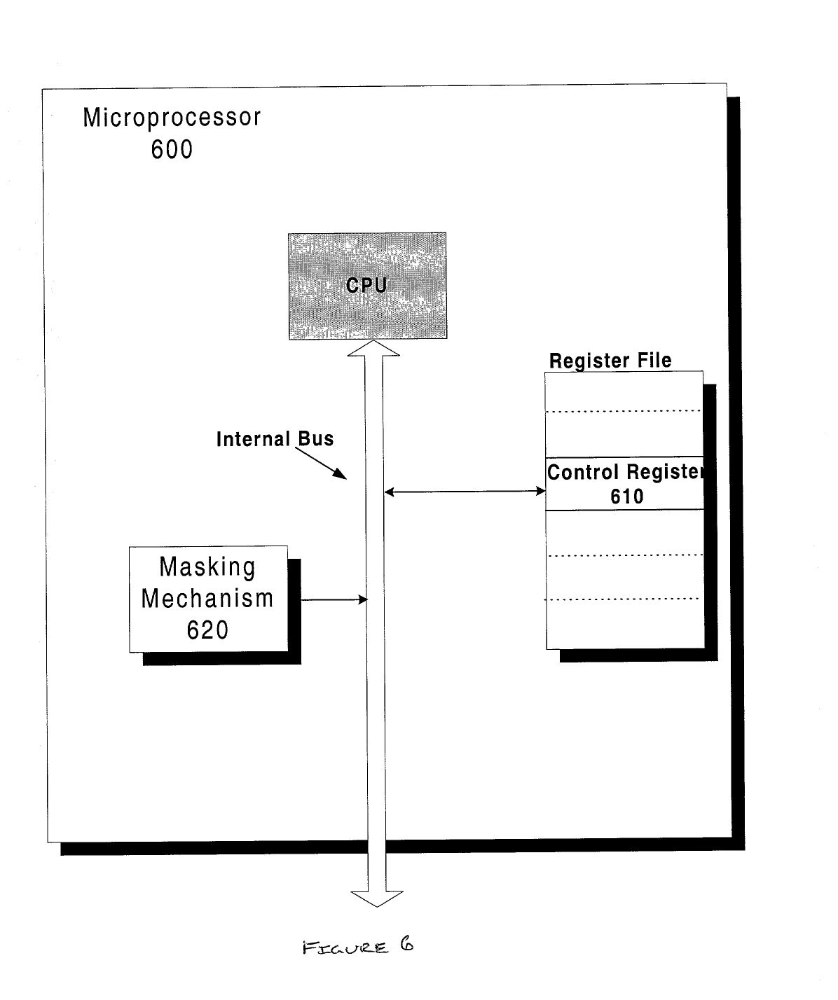

FIG. 6 illustrates one additional alternative embodiment. In the embodiment of FIG. 6, a processor 600 includes a control register 610 and a masking mechanism 620. The masking mechanism 620 may be programmed at various points in time to ensure that a proper mask value for the control register 610 is stored. For example, the masking mechanism may be programmed the time of manufacture of the processor 600 (e.g., may be hard coded, stored in non-volatile memory, or programmed via fuses) or may be programmed during operation by software such as a Basic Input Output System (BIOS) software or operating system software. The BIOS may be programmed when the system is manufactured or may be later delivered via a computer readable medium through the input device 290.

In cases where the BIOS is later delivered, the instructions may be delivered via a computer readable medium. With an appropriate interface device 127 (FIG. 1.), either an electronic signal or a tangible carrier is a computer readable medium. For example, the computer storage device 110 is a computer readable medium in one embodiment. A carrier wave 126 carrying the computer instruction is a computer readable medium in another embodiment. The carrier wave 126 may be modulated or otherwise manipulated to contain instructions that can be decoded by the input device 127 using known or otherwise available communication techniques. In either case, the computer instructions may be delivered via a computer readable medium.It may be advantageous, however, to have the masking mechanism programmed without affecting the operating system to avoid compatibility overhead.

In any case, the masking mechanism 620 (FIG. 6.) is programmed with a masking value that renders inactive any bits of the control register 610 which are “reserved”, undefined, or otherwise not intended for use in the processor 600. In one embodiment, the masking mechanism 620 may be programmed with logical zeroes for such bits and ANDed with a proposed value that is being loaded into the control register 610. In other embodiments, other logical mechanisms may be used, as long as certain bits are masked (to either logical zero or logical one, whichever represents an inactive state). The masking mechanism 620 may alternatively be execution hardware that executes a sequence of instructions and uses of a state save memory map as described above with respect to FIGS. 1-5.

While this invention has been described with reference to illustrative embodiments, this description is not intended to be construed in a limiting sense. Various modifications of the illustrative embodiments, as well as other embodiments , which are apparent to persons skilled in the art to which the invention pertains are deemed to lie within the spirit and scope of the invention.

What is claimed is:

1. A method comprising:
accessing a control register mask;
adjusting a control value for a control register as a function of said control register mask to generate a masked control value;
programming said masked control value into the control register.

2. The method of claim 1 wherein said accessing comprises writing an initial value to at least one address within a memory image.

3. The method of claim 2 wherein said accessing further comprises executing a state save operation.

4. The method of claim 3 wherein said accessing further comprises comparing a saved value to said initial value, said saved value being stored within said memory image as a result of said execution of said state save operation.

5. The method of claim 4 wherein said control register mask comprises a default value if said saved value is equal to said initial value.

6. The method of claim 5 wherein said control register mask comprises said saved value if said saved value is not equal to said initializing value.

7. The method of claim 6 wherein said adjusting comprises performing an AND operation in which said control register mask and said control value are operands.

8. The method of claim 7 wherein said state save operation is an FXSAVE instruction, said FXSAVE instruction having associated with it a target address.

9. The method of claim 8 wherein said target address is an address within said memory image.

10. A machine-readable medium having stored thereon a set of instructions said set of instructions, which when executed by a processor, cause said processor to perform a method comprising:
accessing a control register mask;
adjusting a control value for a control register as a function of said control register mask to generate a masked control value;
programning said masked control value into the control register.

11. The computer-readable medium of claim 10 wherein said accessing comprises writing an initial value to at least one address within a memory image.

12. The computer-readable medium of claim 11 wherein said accessing further comprises executing a state save operation.

13. The computer-readable medium of claim 12 wherein said accessing further comprises comparing a saved value to said initial value, said saved value being stored within said memory image as a result of said execution of said state save operation.

14. The computer-readable medium of claim 13 wherein said control register mask comprises a default value if said saved value is equal to said initial value.

15. The computer-readable medium of claim 14 wherein said control register mask comprises said saved value if said saved value is not equal to said initializing value.

16. The computer-readable medium of claim 15 wherein said adjusting comprises performing an AND operation in which said control register mask and said control value are operands.

17. The computer-readable medium of claim 16 wherein said state save operation is an FXSAVE instruction, said FXSAVE instruction having associated with it a target address.

18. The computer-readable medium of claim 17 wherein said target address is an address within said memory image.

19. An apparatus comprising:
a control register comprising a plurality of bits to provide a plurality of functions;
a masking mechanism to set inactive one or more bits of a control value prior to storage of said one or more bits in the control register.

20. The apparatus of claim 19 further comprising:
a mask storage area to contain a pre-determined mask value, said mask value indicating which of said plurality of functions are available.

21. The apparatus of claim 20 wherein said mask storage area may be accessed by performing a state saving operation which saves said mask value to a memory location.

22. The apparatus of claim 21 wherein said state saving operation is an FXSAVE instruction.

23. The apparatus of claim 19 wherein said masking mechanism is a hardware masking mechanism.

24. The apparatus of claim 19 wherein said masking mechanism comprises:
a sequence of instruction to adjust a control value by saving state information including a control register value to a memory and adjusting said control register value based on a readable mask value read from the processor before restoring the state information;
execution hardware to execute the sequence of instructions.

25. A processor comprising:
a decode unit;
at least one of a plurality of registers, said at least one of a plurality of registers comprising a plurality of bits to provide a plurality of functions;
an execution unit;
an internal bus, said decoder unit, said at least one plurality of registers, said at least one execution unit being coupled by said internal bus.

26. The processor of claim 25, wherein, in response to said execution unit executing an instruction, said plurality of bits are written to a mask storage area.

27. The processor of claim 26 wherein said instruction is an FXSAVE instruction.

28. The processor of claim 27 wherein said at least one of a plurality of registers is an MXCSR register.

29. The processor of claim 28 wherein said at least one mask storage area is an MXCSR_MASK field.
